(19) United States
(12) Patent Application Publication
(10) Pub. No.: US 2023/0138615 A1
(43) Pub. Date: May 4, 2023

(54) AUXILIARY VOLTAGE SUPPLY FOR POWER CONVERTER AND USE THEREOF IN VEHICLES

(71) Applicant: Rolls-Royce Deutschland Ltd & Co KG, Blankenfelde-Mahlow (DE)

(72) Inventor: Christoph Berndt Marxgut, München (DE)

(21) Appl. No.: 17/638,687

(22) PCT Filed: Aug. 19, 2020
(86) PCT No.: PCT/EP2020/073182

§ 371 Date: Nov. 21, 2022

(30) Foreign Application Priority Data
Aug. 30, 2019 (DE) 10 2019 213 168.9

(51) Int. Cl. H02M 7/5387; H02M 7/483; B64D 27/24; B64D 35/00

(52) U.S. Cl. CPC H02M 7/5387; H02M 7/4837; B64D 27/24; B64D 35/00

(57) ABSTRACT

The invention relates to a circuit arrangement (1) for generating an auxiliary DC voltage (VLV), having:—a half bridge circuit (2) which outputs a load current (IL) and which converts a DC voltage (V1) into an AC voltage, and—wherein the half bridge circuit (2) has, in each of the two branches (A1, A2), at least two switch elements (S1, S2 and S3, S4) arranged in series and—wherein a flying capacitor (3) is connected in parallel to corresponding switch elements (S2, S3) in each of the two branches (A1, A2), characterized by:—an auxiliary voltage generating unit (5) which is supplied with electrical energy by the flying capacitor (3) and which is designed to generate an auxiliary DC voltage (VLV) which is less than or equal to 48 V. The invention also relates to an associated method for generating an auxiliary DC voltage and to a power converter and a vehicle having such a circuit arrangement.

### PRIORITY

This application is the National Stage of International Application No. PCT/EP2020/073182, filed Aug. 19, 2020, which claims the benefit of German Patent Application No. DE 10 2019 213 168.9, filed Aug. 30, 2019. The entire contents of these documents are hereby incorporated herein by reference.

### FIELD

The present embodiments relate to a circuit arrangement for generating an auxiliary direct current (DC) voltage for a power converter. The present embodiments also relate to a power converter including a circuit arrangement of this type, and to a vehicle including a power converter of this type. The present embodiments also relate to an associated method for generating an auxiliary DC voltage.

### BACKGROUND

Applications requiring high availability or a very low probability of failure of power electronic power converters in high-voltage technology (e.g., >1 kV) present a particular challenge for the design because these requirements are demanding from both a technical (e.g., weight, efficiency, volume, complexity, etc.) and an economic standpoint.

A central point here is to provide the auxiliary voltage supply of the power converter because the function of the power converter is dependent on the availability of the auxiliary voltage supply.

In aviation applications, auxiliary voltage supplies are embodied with multiple redundancy in order that the failure of one auxiliary voltage branch may be mitigated by other paths. These are either supplied by AC/DC converters from the on-board electrical system (e.g., 115 V/400 Hz) or are supplied by battery systems (e.g., 28 V/DC). The disadvantage of these embodiments is firstly the complexity entailed by the redundancy. Secondly, the weight of the entire auxiliary voltage supply increases as a result, which is disadvantageous particularly in aviation.

The prior art as disclosed in US 2012/0218795 A1, for example, discloses, in the context of power converters, a “flying capacitor topology”, which constitutes a known multilevel topology in power electronics.

The subsequently published patent application DE 10 2019 212 073 A1 discloses a similar topology. FIG. 1 shows a circuit arrangement 1 associated therewith. In this case, a DC input voltage V₁ is converted into an alternating current (AC) output voltage for supplying a phase of a three-phase electrical machine 11. For this purpose, the input voltage V₁, buffered by link circuit capacitors 4, is fed to a half-bridge circuit 2. The half-bridge circuit 2 is formed by a first branch A₁ and a second branch A₂. The half-bridge circuit 2 converts the DC voltage into an AC voltage.

Unlike in conventional topologies, the half-bridge circuit is not constituted by two switching elements, in the case of which the center point is fed to a load, but rather by four switching elements S₁ to S₄. The switching elements S₁ to S₄ may be semiconductor components.

The first switching element S₁ and the second switching element and S₂, which switch simultaneously, form the first branch A₁, and the third switching element S₃ and the fourth switching element S₄, which switch simultaneously, form the second branch A₂. The series connection of the switching elements S₁ and S₂ and respectively S₃ and S₄ enables the input voltage V₁ to be divided between, in each case, two switching elements S₁ and S₂ and respectively S₃ and S₄ of the corresponding branches A₁ and respectively A₂. Accordingly, it is possible to use switching elements S₁ to S₄ with a rated voltage approximately equal to half the input voltage V₁. In this case, it is only necessary to provide that the voltage division of the two switching elements S₁ and S₂ and respectively S₃ and S₄ is equal in each case, since, otherwise, one or more of the switching elements S₁ to S₄ is overloaded in terms of voltage and/or in terms of current. As a result of this, the entire circuit arrangement 1 may be destroyed.

In order to achieve as uniform a division of the input voltage V₁ as possible, a flying capacitor 3 is arranged in parallel on the input side at the half-bridge circuit 2 and keeps the voltages of the switching elements S₁ and S₂ and respectively S₃ and S₄ virtually constant even during the commutation period. As a result, a large voltage unbalance cannot form in the case of non-identical switching on and off times of the switching elements S₁ and S₂ and respectively S₃ and S₄ in the branches A₁ and respectively A₂.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a solution for an auxiliary voltage supply for power converters that is less complex and has less weight by comparison with the prior art is provided.

A first aspect of the present embodiments consists in the fact that an inherently necessary capacitor of a power converter is used for supplying an auxiliary voltage generating unit. This may be provided in the case of multilevel topologies, for example, as illustrated in FIG. 1, because capacitors that have not applied the full link circuit voltage are required here. The switches of the auxiliary voltage generating unit and the insulation thus do not have to be designed for the entire link circuit voltage, which reduces the costs, the weight, and the complexity of the power converter.

In one embodiment, the intention is to actively control the voltage of the tapped capacitor in the high-voltage circuit since otherwise the operation of the primary power converter may be disturbed or even interrupted. This is continuously provided, however, in the case of the abovementioned modular multilevel, quasi-multilevel, and nL flying capacitor topologies.

The present embodiments include a circuit arrangement for generating an auxiliary DC voltage. The circuit arrangement includes a half-bridge circuit that outputs a load current and converts a DC voltage into an AC voltage. The half-bridge circuit has, in each of two branches, at least two switching elements arranged in series. A flying capacitor is connected in parallel with respectively corresponding switching elements of the two branches. The circuit arrangement also includes an auxiliary voltage generating unit supplied with electrical energy by the flying capacitor and configured to generate an auxiliary DC voltage of less than or equal to 48 V.

In one development, the voltage at the flying capacitor may be controllable by a choice of switching times of the switching elements.

In a further configuration, the circuit arrangement has at least two link circuit capacitors arranged in series on the input side in parallel with the half-bridge circuit.

In a development, the auxiliary voltage generating unit has a full-bridge circuit, a transformer supplied by the full-bridge circuit, and a rectifier circuit supplied by the transformer.

The present embodiments also include a power converter (e.g., an inverter) including a circuit arrangement according to the present embodiments.

Inverter denotes a power converter that generates an AC voltage from a DC voltage, the frequency and amplitude of the AC voltage being varied. An output AC voltage is generated from an input DC voltage by a DC voltage link circuit and clocked semiconductor switches.

The present embodiments also include a vehicle (e.g., an aircraft) including a power converter according to the present embodiments for an electric or hybrid electric drive.

A vehicle may be any type of means of locomotion or transport means, whether manned or unmanned. An aircraft is a flying vehicle.

In a further configuration, the vehicle includes an electric motor supplied with electrical energy by the power converter, and a propeller that may be set in rotation by the electric motor.

The present embodiments include a method for generating an auxiliary DC voltage includes outputting, by-a half-bridge circuit, a load current and converting, by the half-bridge circuit, a DC voltage into an AC voltage. The half-bridge circuit has, in each of two branches, at least two switching elements arranged in series. A flying capacitor is connected in parallel with respectively corresponding switching elements of the two branches. The method also includes supplying an auxiliary voltage generating unit with electrical energy from the flying capacitor. The auxiliary DC voltage of less than or equal to 48 V is generated.

### BRIEF DESCRIPTION OF THE DRAWINGS

FIG. 1 shows a circuit diagram of a circuit arrangement in accordance with the prior art;

FIG. 2 shows a block diagram of one embodiment of a circuit arrangement with auxiliary voltage generating unit;

FIG. 3 shows a circuit diagram of one embodiment of a circuit arrangement with auxiliary voltage generating unit;

FIG. 4 shows a block diagram of one embodiment of a power converter; and5

FIG. 5 shows one embodiment of an aircraft including a power converter.

### DETAILED DESCRIPTION

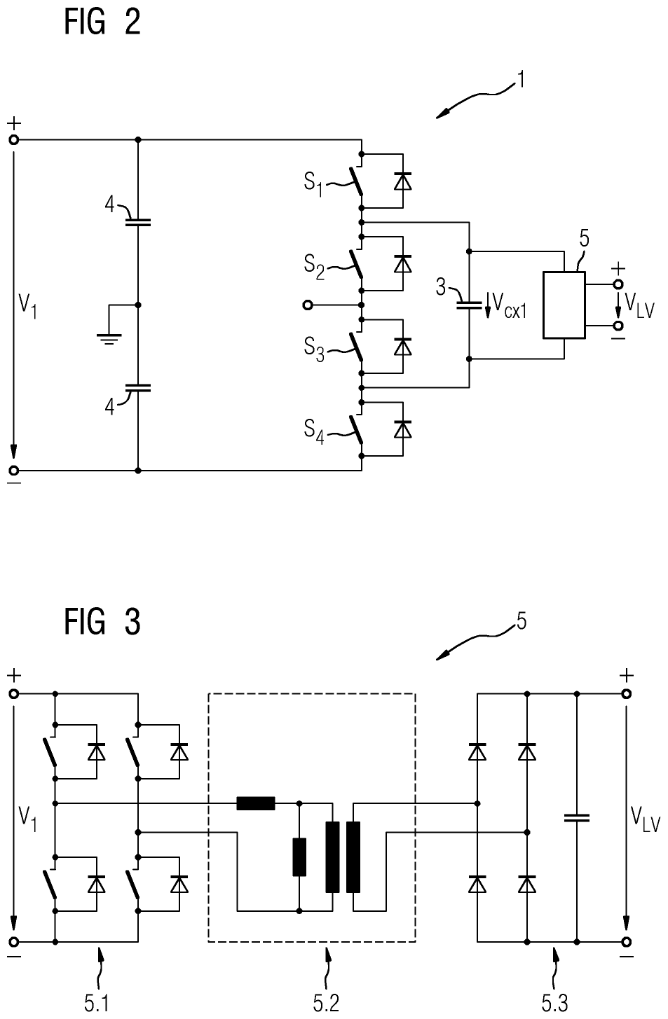

FIG. 2 shows auxiliary voltage architecture according to the present embodiments based on the example of a quasi-2L converter (only one phase is illustrated, however). In this case, a voltage at a flying capacitor 3 is controlled by the offset of the switching on times of the switching elements S₁ to S₄; the flying capacitor 3 is provided for stabilizing the switching transients and simultaneously forms an input capacitor of an auxiliary voltage generating unit 5.

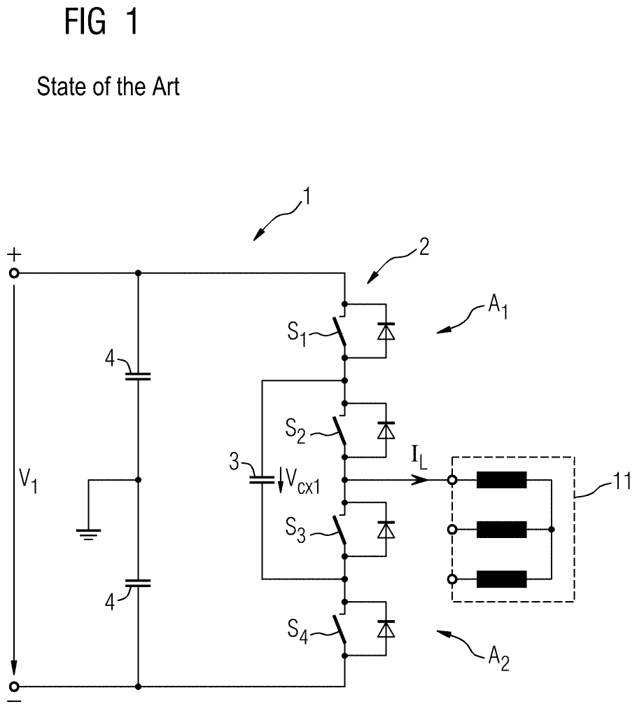

FIG. 2 shows a circuit arrangement 1 in accordance with FIG. 1, including a half-bridge circuit 2 and a parallel flying capacitor 3. The auxiliary voltage generating unit 5 is arranged in parallel with the flying capacitor 3 and is supplied by the electrical energy stored in the flying capacitor 3. The auxiliary voltage generating unit 5 generates an auxiliary DC voltage VLV of less than or equal to 48 V.

FIG. 3 shows one example of a circuit of the auxiliary voltage generating unit 5. A full-bridge circuit 5.1 is situated on an input side and generates an AC voltage from an input DC voltage. The AC voltage is fed to a transformer 5.2 for the purpose of potential isolation. On an output side, a rectifier circuit 5.3 is connected to the transformer 5.2. The auxiliary DC voltage VLv is then available at the output of the rectifier circuit 5.3.

A topology of the auxiliary voltage generating unit 5 may be chosen and designed by the designer freely, in principle, but is to provide the transformer 5.2 for the purpose of voltage isolation on account of the potential at the flying capacitor 3.

An advantage of this architecture is that the switches of the full-bridge circuit are not loaded with the full link circuit voltage (e.g., >1 kV) but rather with the maximum voltage at the flying capacitor 3, which is significantly smaller depending on the number of levels. Switches with the same voltage requirement as in the power circuit (e.g., switching elements S₁ to S₄) may thus be incorporated (e.g., but with a lower current requirement).

In this context, however, it may also already be predicted that the flyback topology that is very popular for auxiliary voltage converters is not optimal here because the topology, with respect to the input voltage, additionally applies the transformed output voltage to the switches.

For the case of a redundant auxiliary voltage architecture, either the magnetic circuit of the transformer may be additionally tapped, or the energy is supplied via diodes to the capacitor at the output. With the architecture in any case, a supply path from high voltage to low voltage may have been produced in a suitable manner, which has been possible hitherto only using additional high-voltage auxiliary converters.

The concept presented here may be used either as a “stand-alone” auxiliary voltage supply for AC/DC, DC/AC and DC/DC multilevel power converters (e.g., quasi multilevel power converters), or as an additional auxiliary voltage branch for critical applications, such as in aviation, for example.

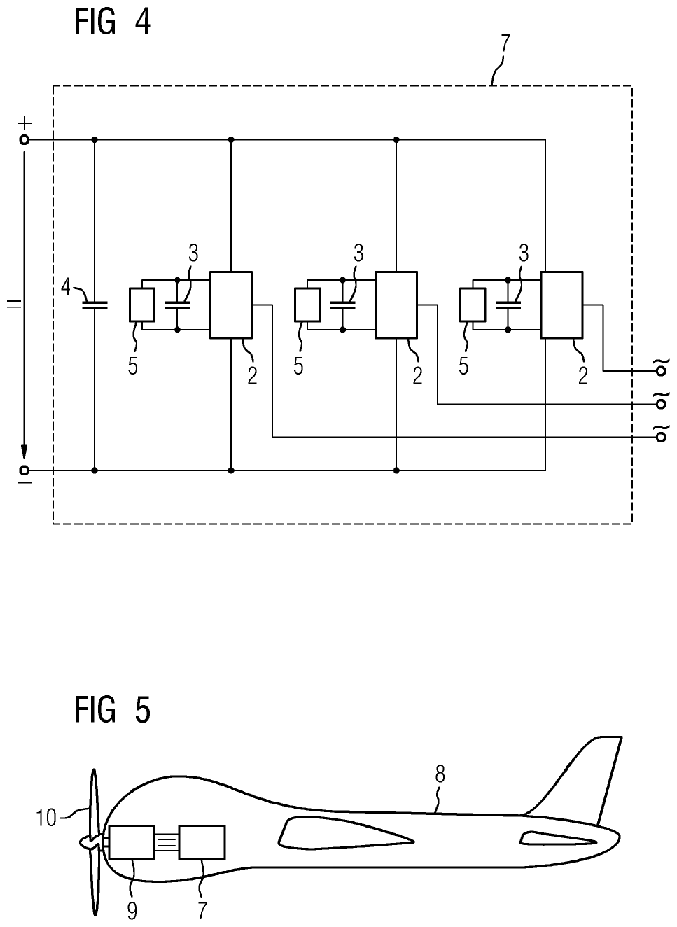

FIG. 4 shows a block diagram of one embodiment of a DC/AC power converter 7 (e.g., of an inverter) including a circuit arrangement for generating a three-phase AC voltage. For this purpose, a half-bridge circuit 2 together with flying capacitor 3 are embodied for each phase. The half-bridge circuit 2 is supplied with DC voltage by a link circuit capacitor 4. Each flying capacitor 3 supplies a respective auxiliary voltage generating unit 5.

FIG. 5 shows one embodiment of an electric or hybrid electric aircraft 8 (e.g., an airplane) including a power converter 7 in accordance with FIG. 4 that supplies an electric motor 9 with electrical energy. The electric motor 9 drives a propeller 10. The electric motor 9 and the propeller 10 are part of an electrical thrust-generating unit. A power converter 7 may also be part of an on-board electrical system.

Although the invention has been described and illustrated more specifically in detail using the exemplary embodiments, the invention is not restricted by the disclosed examples, and other variations may be derived therefrom by a person skilled in the art without departing from the scope of protection of the invention.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A circuit arrangement for generating an auxiliary direct current (DC) voltage, the circuit arrangement comprising:
a half-bridge circuit configured to output a load current and convert a DC voltage into an alternating current (AC) voltage, wherein the half-bridge circuit includes, in each of two branches, at least two switching elements arranged in series;
a flying capacitor that is connected in parallel with respectively corresponding switching elements of the two branches; and
an auxiliary voltage generating unit supplied with electrical energy by the flying capacitor and configured to generate the auxiliary DC voltage of less than or equal to 48 V.

2. The circuit arrangement of claim 1, wherein a voltage at the flying capacitor is controllable by a choice of switching times of the switching elements.

3. The circuit arrangement of claim 1, further comprising at least two link circuit capacitors arranged in series on an input side in parallel with the half-bridge circuit.

4. The circuit arrangement of claim 1, wherein the auxiliary voltage generating unit comprises:
a full-bridge circuit;
a transformer supplied by the full-bridge circuit; and
a rectifier circuit supplied by the transformer.

5. A power converter comprising:
a circuit arrangement for generating an auxiliary direct current (DC) voltage, the circuit arrangement comprising:
a half-bridge circuit configured to output a load current and convert a DC voltage into an alternating current (AC) voltage, wherein the half-bridge circuit includes, in each of two branches, at least two switching elements arranged in series;
a flying capacitor that is connected in parallel with respectively corresponding switching elements of the two branches; and
an auxiliary voltage generating unit supplied with electrical energy by the flying capacitor and configured to generate an auxiliary DC voltage of less than or equal to 48 V.

6. The power converter of claim 5, wherein the power converter is an inverter.

7. A vehicle comprising:
a power converter comprising:
a circuit arrangement for generating an auxiliary direct current (DC) voltage, the circuit arrangement comprising:
a half-bridge circuit configured to output a load current and convert a DC voltage into an alternating current (AC) voltage, wherein the half-bridge circuit includes, in each of two branches, at least two switching elements arranged in series;
a flying capacitor that is connected in parallel with respectively corresponding switching elements of the two branches; and
an auxiliary voltage generating unit supplied with electrical energy by the flying capacitor and configured to generate an auxiliary DC voltage of less than or equal to 48 V.

8. The vehicle claim 7, wherein the vehicle is an aircraft.

9. The vehicle of claim 8, further comprising:
an electric motor supplied with electrical energy by the power converter; and
a propeller that is settable in rotation by the electric motor.

10. A method for generating an auxiliary direct current (DC) voltage, the method comprising:
outputting, by a half-bridge circuit, a load current;
converting, by the half-bridge circuit, a DC voltage into an AC voltage, wherein the half-bridge circuit includes, in each of two branches, at least two switching elements arranged in series, and wherein a flying capacitor is connected in parallel with respectively corresponding switching elements of the two branches; and
supplying an auxiliary voltage generating unit with electrical energy from the flying capacitor, such that the auxiliary DC voltage is generated, the auxiliary DC voltage being less than or equal to 48 V.

11. The power converter of claim 5, wherein a voltage at the flying capacitor is controllable by a choice of switching times of the switching elements.

12. The power converter of claim 5, wherein the circuit arrangement further comprises at least two link circuit capacitors arranged in series on an input side in parallel with the half-bridge circuit.

13. The power converter of claim 5, wherein the auxiliary voltage generating unit comprises:
a full-bridge circuit;
a transformer supplied by the full-bridge circuit; and
a rectifier circuit supplied by the transformer.

14. The vehicle of claim 7, wherein a voltage at the flying capacitor is controllable by a choice of switching times of the switching elements.

15. The vehicle of claim 7, wherein the circuit arrangement further comprises at least two link circuit capacitors arranged in series on an input side in parallel with the half-bridge circuit.

16. The vehicle of claim 7, wherein the auxiliary voltage generating unit comprises:
a full-bridge circuit;
a transformer supplied by the full-bridge circuit; and
a rectifier circuit supplied by the transformer.
